(19) United States
(12) Patent Application Publication
(10) Pub. No.: US 2021/0182269 A1
(43) Pub. Date: Jun. 17, 2021

(54) SYSTEM FOR REINFORCING RESOURCE INTEGRITY BASED ON EVENT IMPACT ANALYSIS

(71) Applicant: BANK OF AMERICA CORPORATION, Charlotte, NC (US)

(72) Inventors: Salvatore Michael Certo, Charlotte, NC (US); Timothy J. Bendel, Charlotte, NC (US); Robin Jennifer Buck, West Palm Beach, FL (US); Christine B. Hoagland, Belmont, NC (US); Todd Lowney, Jacksonville, FL (US); Ashley Diane Meadows, Charlotte, NC (US)

(73) Assignee: BANK OF AMERICA CORPORATION, Charlotte, NC (US)

(21) Appl. No.: 16/710,872

(22) Filed: Dec. 11, 2019

(51) Int. Cl. G06F 16/23; G06F 16/951

(52) U.S. Cl. CPC G06F 16/2365; G06F 16/951

(57) ABSTRACT

Embodiments of the present invention provide a system for reinforcing resource integrity of one or more resources based on performing event impact analysis. The system is configured for determining occurrence of an event based on identifying one or more triggers, performing event impact analysis associated with one or more resources of an entity, and initiating an event response based on performing event impact analysis, wherein the event response comprises initiating one or more actions to reinforce and retain resource integrity of the one or more resources.

### BACKGROUND

Conventional systems do not have the ability to effectively reinforce and retain integrity of resources after occurrence of an event. As such, there exists a need for a system to reinforce and retain integrity of resources.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for reinforcing and retaining resource integrity based on performing event impact analysis. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

In some embodiments, the present invention determines occurrence of an event based on identifying one or more triggers, performs event impact analysis associated with one or more resources of an entity; and initiates an event response based on performing event impact analysis, wherein the event response comprises initiating one or more actions to reinforce and retain resource integrity of the one or more resources.

In some embodiments, the present invention determines occurrence of the event based on receiving an input from at least one user of at least one resource of the one or more resources.

In some embodiments, the present invention determines occurrence of the event based on crawling into the one or more resources and monitoring error logs of the one or more resources.

In some embodiments, performing the impact analysis comprises gathering one or more parameters associated with the one or more resources, wherein the one or more parameters comprise provisioning frequency and dependencies of the one or more resources and generating a propagation model associated with the one or more resources, wherein the propagation model comprises the one or more parameters.

In some embodiments, initiating the one or more actions comprises identifying a version of a resource that is not impacted by the event based on the propagation model and propagating the version of the resource to the one or more resources.

In some embodiments, initiating the one or more actions comprises generating one or more alerts associated with the event, identifying at least one resource that is to be impacted at a future time period based on the provisioning frequency and dependencies in the propagation model, and transmitting the one or alerts to one or more users associated with the at least one resource.

In some embodiments, initiating the one or more actions comprises automatically modifying the provisioning frequency associated with the one or more models

In some embodiments, initiating the one or more actions comprises identifying at least one high impact resource from the one or more resources based on the propagation model and automatically decommissioning the at least one high impact resource.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for reinforcing and retaining resource integrity based on performing event impact analysis, in accordance with an embodiment of the invention;

FIG. 2 provides a block diagram illustrating the entity system 200 of FIG. 1, in accordance with an embodiment of the invention;

FIG. 3 provides a block diagram illustrating a resource integrity reinforcement application 300 of FIG. 1, in accordance with an embodiment of the invention;

FIG. 4 provides a block diagram illustrating the computing device system 400 of FIG. 1, in accordance with an embodiment of the invention;

FIG. 5 provides a flowchart illustrating a process flow for reinforcing and retaining resource integrity based on performing event impact analysis, in accordance with an embodiment of the invention;

FIG. 6 illustrates a block diagram illustrating the provision frequency attribute employed by the resource integrity reinforcement system 300 to reinforce the resource integrity, in accordance with an embodiment of the invention; and

FIGS. 7A, 7B, and 7C illustrate propagation models generated by the resource integrity reinforcement system 300, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “entity” may include any organization that processes financial transactions including, but not limited to, banks, credit unions, savings and loan associations, investment companies, stock brokerages, management firms, insurance companies and the like. In accordance with embodiments of the invention, the terms “third party system” and “other third party systems” may include any organization that processes financial transactions including, but not limited to, banks, credit unions, savings and loan associations, investment companies, stock brokerages, management firms, insurance companies and the like. Furthermore, embodiments of the present invention use the term “user.” In accordance with embodiments of the invention, a user may be an employee or a customer of the entity.

In accordance with embodiments of the invention, the term “resource” may be an application, a document, or the like associated with the entity. In specific embodiments of the invention, the resource may be an application utilized, managed, and/or developed by the entity. In some embodiments of the invention, the resource may be a server. In some embodiments of the invention, the resource may be a database.

In accordance with embodiments of the invention, the term “event” may be any event that disrupts the normal operation of the one or more resources. In some embodiments, the event may be a security related event (e.g., unauthorized data modification event).

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more resources or portions of a resource. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface include a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

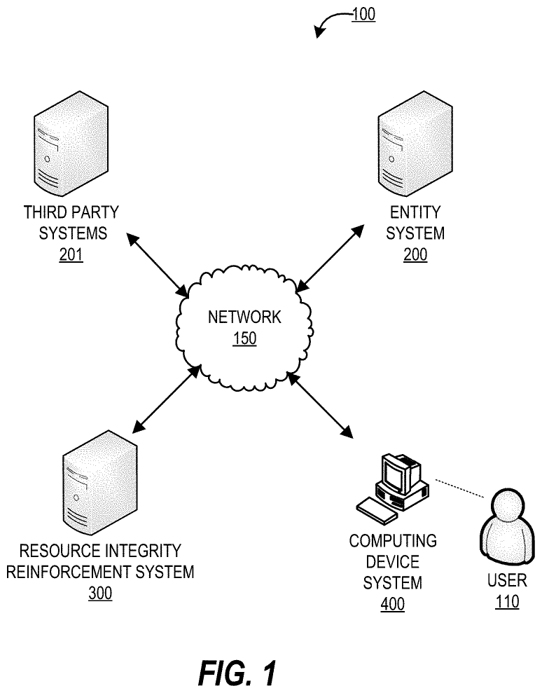

FIG. 1 provides a block diagram illustrating a system environment 100 for reinforcing and retaining resource integrity based on performing event impact analysis, in accordance with an embodiment of the invention. As illustrated in FIG. 1, the environment 100 includes a resource integrity reinforcement system 300, entity system 200, a computing device system 400, and third party systems 201. One or more users 110 may be included in the system environment 100, where the users 110 interact with the other entities of the system environment 100 via a user interface of the computing device system 400. In some embodiments, the one or more user(s) 110 of the system environment 100 may be customers of an entity associated with the entity system 200. In some other embodiments, the one or more users 110 may be employees of the entity.

The entity system(s) 200 may be any system owned or otherwise controlled by an entity to support or perform one or more process steps described herein. In some embodiments, the managing entity is a financial institution. In some embodiments, the managing entity is a non-financial institution. In some embodiments, the entity system 200 may include one or more independent systems that manage one or more applications. In some embodiments, the entity system 200 may include one or more servers.

Third party systems 201 may be any systems that provide one or more resources to the entity. In some embodiments, the third party systems 201 may be a system that provides an application to the entity. In some embodiments, the third party systems 201 may be a system that provides a server to the entity. In some embodiments, the third party systems 201 may be a system that provides a database to the entity.

The resource integrity reinforcement system 300 is a system of the present invention for performing one or more process steps described herein. In some embodiments, the resource integrity reinforcement system 300 may be an independent system. In some embodiments, the resource integrity reinforcement system 300 may be a part of the entity system 200.

The resource integrity reinforcement system 300, the entity system 200, the computing device system 400, and/or the third party systems 201 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the resource integrity reinforcement system 300 is configured to communicate information or instructions with the entity system 200, the computing device system 400, and/or the third party systems 201 across the network 150.

The computing device system 400 may be a system owned or controlled by the entity of the entity system 200, the user 110, and/or a third party. As such, the computing device system 400 may be a computing device of the user 110. In general, the computing device system 400 communicates with the user 110 via a user interface of the computing device system 400, and in turn is configured to communicate information or instructions with the resource integrity reinforcement system 300, entity system 200, and/or the third party systems 201 across the network 150.

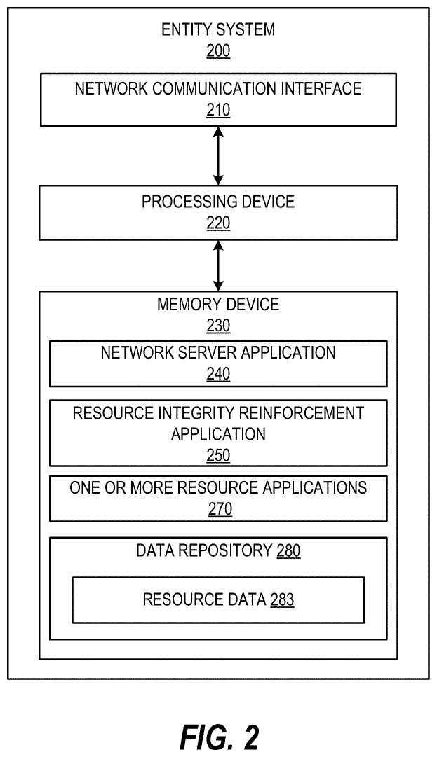

FIG. 2 provides a block diagram illustrating the entity system 200, in greater detail, in accordance with embodiments of the invention. As illustrated in FIG. 2, in one embodiment of the invention, the entity system 200 includes one or more processing devices 220 operatively coupled to a network communication interface 210 and a memory device 230. In certain embodiments, the entity system 200 is operated by a first entity, such as a financial institution, while in other embodiments, the entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a resource integrity reinforcement application 250, one or more resource applications 270, and a data repository 280 comprising resource data 283. The computer-executable program code of the network server application 240, the resource integrity reinforcement application 250, the one or more resource applications 270, to perform certain logic, data-extraction, and data-storing functions of the entity system 200 described herein, as well as communication functions of the entity system 200.

The network server application 240, the resource integrity reinforcement application 250, the one or more resource applications 270, are configured to store data in the data repository 280 or to use the data stored in the data repository 280 when communicating through the network communication interface 210 with the resource integrity reinforcement system 300, the computing device system 400, and/or the third party systems 201 to perform one or more process steps described herein. In some embodiments, the entity system 200 may receive instructions from the resource integrity reinforcement system 300 via the resource integrity reinforcement application 250 to perform certain operations. The resource integrity reinforcement application 250 may be provided by the resource integrity reinforcement system 300. The one or more resource applications 270 may be any of the applications used, created, modified, and/or managed by the entity system 200.

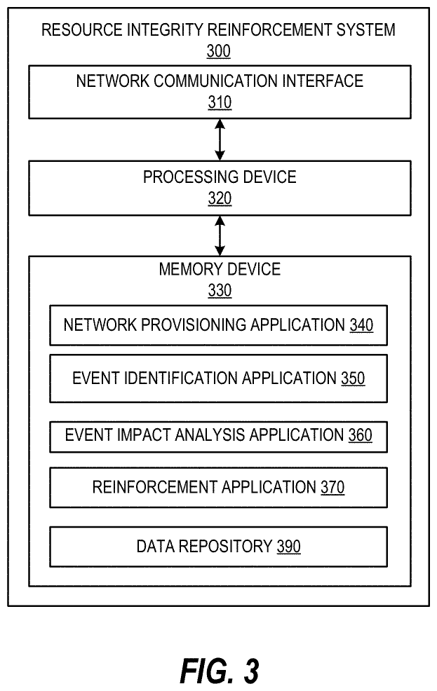

FIG. 3 provides a block diagram illustrating the resource integrity reinforcement system 300 in greater detail, in accordance with embodiments of the invention. As illustrated in FIG. 3, in one embodiment of the invention, the resource integrity reinforcement system 300 includes one or more processing devices 320 operatively coupled to a network communication interface 310 and a memory device 330. In certain embodiments, the resource integrity reinforcement system 300 is operated by a first entity, such as a financial institution, while in other embodiments, the resource integrity reinforcement system 300 is operated by an entity other than a financial institution. In some embodiments, the resource integrity reinforcement system 300 is owned or operated by the entity of the entity system 200. In some embodiments, the resource integrity reinforcement system 300 may be an independent system. In alternate embodiments, the resource integrity reinforcement system 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the resource integrity reinforcement system 300 described herein. For example, in one embodiment of the resource integrity reinforcement system 300, the memory device 330 includes, but is not limited to, a network provisioning application 340, an event identification application 350, an event impact analysis application 360, a reinforcement application 370, and a data repository 390 comprising data processed or accessed by one or more applications in the memory device 330. The computer-executable program code of the network provisioning application 340, the event identification application 350, the event impact analysis application 360, and the reinforcement application 370 may instruct the processing device 320 to perform certain logic, data-processing, and data-storing functions of the resource integrity reinforcement system 300 described herein, as well as communication functions of the resource integrity reinforcement system 300.

The network provisioning application 340, the event identification application 350, the event impact analysis application 360, and the reinforcement application 370 are configured to invoke or use the data in the data repository 390 when communicating through the network communication interface 310 with the entity system 200, the computing device system 400, and/or the third party systems 201. In some embodiments, the network provisioning application 340, the event identification application 350, the event impact analysis application 360, and the reinforcement application 370 may store the data extracted or received from the entity system 200, the third party system 201, and the computing device system 400 in the data repository 390. In some embodiments, the network provisioning application 340, the event identification application 350, the event impact analysis application 360, and the reinforcement application 370 may be a part of a single application.

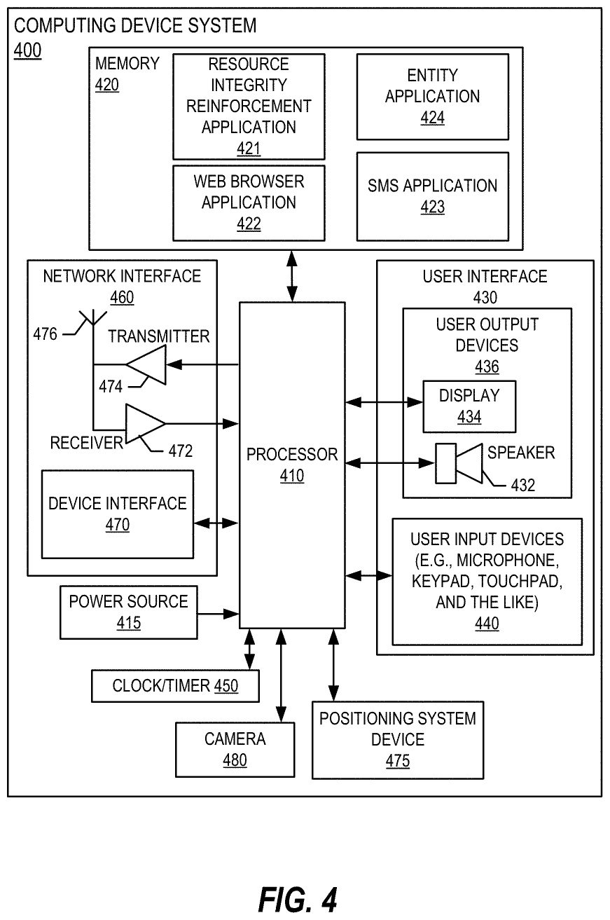

FIG. 4 provides a block diagram illustrating a computing device system 400 of FIG. 1 in more detail, in accordance with embodiments of the invention. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a resource integrity reinforcement application 421, entity application 424. These applications also typically instructions to a graphical user interface (GUI) on the display 430 that allows the user 110 to interact with the entity system 200, the resource integrity reinforcement system 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the resource integrity reinforcement application 421 provided by the resource integrity reinforcement system 300 allows the user 110 to access the resource integrity reinforcement system 300. In some embodiments, the entity application 424 provided by the entity system 200 and the resource integrity reinforcement application 421 allow the user 110 to access the functionalities provided by the resource integrity reinforcement system 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

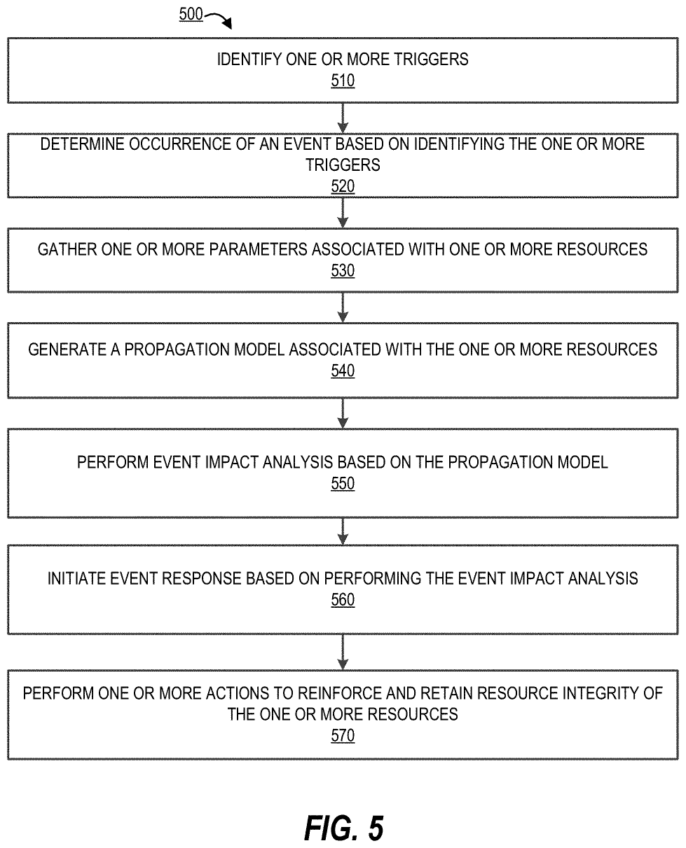

FIG. 5 provides a flowchart illustrating a process flow for reinforcing and retaining resource integrity based on performing event impact analysis, in accordance with an embodiment of the invention.

As shown in block 510, the system identifies one or more triggers. The one or more triggers may include, but are not limited to, receiving an input from a user, receiving an input from a third party system, an error message from an error log associated with at least one resource, or the like. In one embodiment, the system may crawl into the one or more resources and monitors the error logs of the one or more resources to identify one or more triggers. In another embodiment where the entity operating the system of the present invention uses third party applications, the system may receive an input associated with an event from a third party entity.

As shown in block 520, the system determines occurrence of an event based on identifying the one or more triggers. In an exemplary embodiment where the system monitors the error logs associated with the one or more resources, the system may identify an error message and determine the occurrence of the event. For example, the system may identify a data corruption error associated with an application and may determine occurrence of an unauthorized data modification event. In another embodiment, the system may receive a security related alert from a user and may determine the occurrence of a security event. In some embodiments, the event may be associated with one resource at the time of occurrence of an event. For example, a security event may occur in a first application based on an unauthorized action and the system identifies the first application as the primary source associated with the event.

As shown in block 530, in response to identifying the occurrence of the event, the system gathers one or more parameters associated with one or more resources. In some embodiments, the one or more resources may be resources that are associated with the primary source of the event. For example, the system may identify that the primary application that was affected and may identify one or more applications that are associated with the primary application, where the one or more applications may be upstream applications and/or downstream applications. The one or more parameters may include, but are not limited to, network traffic, provisioning frequency, dependencies, backup timing, or the like. The provisioning frequency is the frequency at which data is transferred between the one or more resources. Backup timing is a time at which backup of the one or more resources is scheduled to be performed.

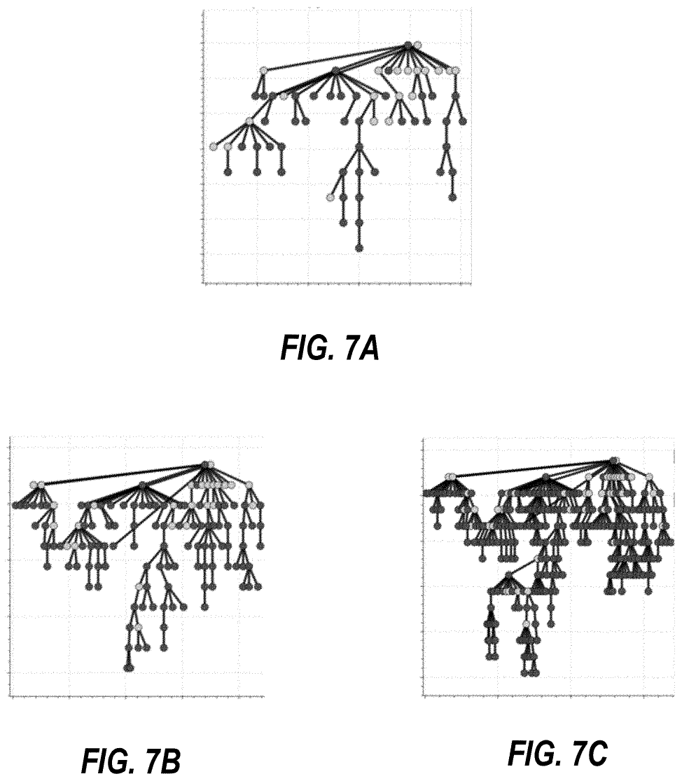

As shown in block 540, the system generates a propagation model associated with the one or more resources. The propagation model comprises the one or more parameters. For example, the system identifies that (i) a third application is dependent on a first application and a second application based on dependency data, (ii) the first application propagates data to the third application at a scheduled time T1 and the second application propagates data to the third application at a scheduled time T2 based on provisioning frequency data, and (iii) the third application is performing calculations and is transmitting data in real-time to a fourth application based on the network traffic data and generates a propagation model comprising the network traffic data, dependency data, and provisioning frequency data associated with the first application, the second application, third application, and the fourth application. In some embodiments, the propagation model generated by the system may be a directed graph. Examples of propagation models generated by the system are illustrated in FIGS. 7A-7C.

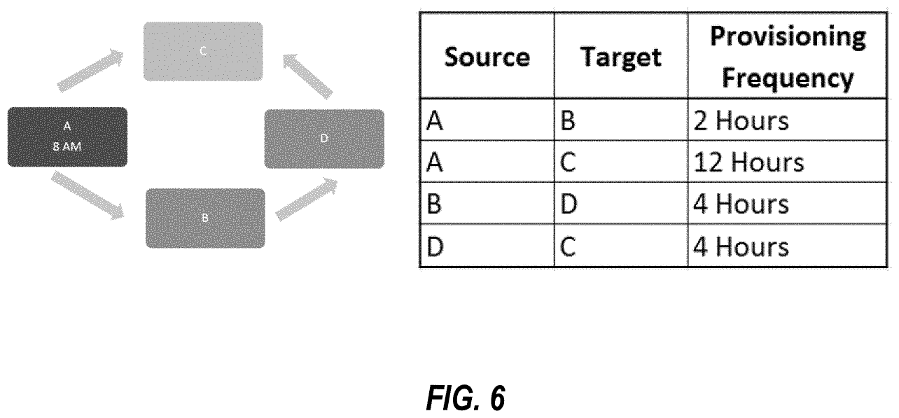

As shown in block 550, the system performs event impact analysis based on the propagation model. The system identifies the high impact resources based on the propagation model. For example, the system identifies that a second resource provides data to ten resources downstream and determines that the second resource is a high impact resource. The system, instead of merely considering lineage or dependency data, considers other parameters including provisioning frequency while identifying high impact resources. Such an example is illustrated in FIG. 6. As shown in FIG. 6, resource ‘A’ propagates data to resource ‘C’ and resource ‘B.’ Resource ‘B’ propagates data to resource ‘D’ which in turn propagates data to resource ‘C.’ However, the provisioning frequency associated with the resources varies as illustrated in the table in FIG. 6. As shown, based on the table, the system identifies that the propagation between resource ‘A’ and resource ‘B’ happens for every two hours, propagation between resource ‘A’ and resource ‘C’ happens for every twelve hours, propagation between resource ‘B’ and resource ‘D’ happens for every four hours, and propagation between resource ‘D’ and resource ‘C’ happens for every four hours. The system identifies that two paths exist between resource ‘A’ and resource ‘C’ based on the dependency data. The first path is the direct path between resource ‘A’ and resource ‘C.’ The second path comprises propagation from resource ‘A’ to resource ‘B,’ resource ‘B’ to resource ‘D,’ and resource ‘D’ to resource ‘C.’ However, the system identifies that resource ‘C’ may be impacted by the longer path earlier than the direct path based on provisioning frequency. The system may identify high impact paths and generate and prioritize one or more alerts as explained below based on the high impact paths, where a user may perform mitigation steps based on the alerts to rectify the resources associated with the high impact path first. In some embodiments, the system may utilize breadth first search queue on the propagation model while performing the event impact analysis.

As shown in block 560, the system initiates event response based on performing the event impact analysis. As shown in block 570, the system, in response to initiating the event response, performs one or more actions to reinforce and retain resource integrity of the one or more resources. In one embodiment, the one or more actions comprise identifying a version of a resource that is not impacted by the event based on the propagation model and propagating the version of the resource to the one or more resources. For example, the system may identify a last good copy of a resource and propagate the last good copy to all the other resources that are downstream. In another example, the system may identify that a user may retrieve and utilize a backup of a first resource in the morning and may notify the user to use the identified last good copy. The system may automatically transmit the last good copy to a user device of the user.

In one embodiment, the one or more actions comprise generating one or more alerts associated with the event, identifying at least one resource that is to be impacted at a future time period based on the provisioning frequency and dependencies in the propagation model, and transmitting the one or alerts to one or more users associated with the at least one resource. For example, the system may identify that a first resource is set to be impacted by the event at time period T1 and may transmit a notification to an employee that maintains the first resource. In another embodiment, the one or more actions comprise automatically modifying the provisioning frequency associated with the one or more models. In yet another embodiment, the one or more actions comprise identifying at least one high impact resource from the one or more resources based on the propagation model and automatically decommissioning the at least one high impact resource.

In some embodiments, the system provides a propagation platform, where one or more users utilize the platform to perform static event analysis based on passing one or more inputs to the system via the propagation platform. In some embodiments, the user may utilize the platform to perform real-time event analysis. In such embodiments, the one or more users may use the propagation platform provided by the system to actively analyze health of the one or more resources and predict vulnerabilities associated with the one or more resources. In some embodiments, the system may present the generated propagation models and alerts associated with the event to the one or more users via the propagation platform. In some embodiments, the system may generate multiple propagation models for different time periods to illustrate future event impact to the user as illustrated in FIGS. 7A-7C. FIG. 7A illustrates a propagation model at time period T1 where ‘X’ number of resources are impacted. FIG. 7B illustrates a propagation model at time period T2 where ‘Y’ number of resources are impacted. FIG. 7C illustrates a propagation model at time period T3 where ‘Z’ number of resources are impacted, where T1<T2<T3 and X<Y<Z.

In some embodiments, the system allows the user to provide real-time status updates about one or more resources after the occurrence of an event. In one exemplary embodiment, the system allows one or more users to report that a resource was not impacted by the event. In such a case, the system may update the event impact analysis process and may not generate and transmit alerts associated with the resource. In another exemplary embodiment, the system allows the one or more users to report completion of mitigation steps associated with one or more resources. In such a case, the system based on the report from the user, updates the event impact analysis and the propagation models dynamically, thereby improving the efficiency of the event impact analysis process.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for reinforcing resource integrity of one or more applications based on event impact analysis, the system comprising:
at least one network communication interface;
at least one non-transitory storage device; and
at least one processing device coupled to the at least one non-transitory storage device and the at least one network communication interface, wherein the at least one processing device is configured to:
determine occurrence of an event based on identifying one or more triggers;
perform event impact analysis associated with one or more resources of an entity; and
initiate an event response based on performing event impact analysis, wherein the event response comprises initiating one or more actions to reinforce and retain resource integrity of the one or more resources.

2. The system of claim 1, wherein the at least one processing device is configured to determine occurrence of the event based on receiving an input from at least one user of at least one resource of the one or more resources.

3. The system of claim 1, wherein the at least one processing device is configured to determine occurrence of the event based on:
crawling into the one or more resources; and
monitoring error logs of the one or more resources.

4. The system of claim 1, wherein performing the impact analysis comprises:
gathering one or more parameters associated with the one or more resources, wherein the one or more parameters comprise provisioning frequency and dependencies of the one or more resources; and
generating a propagation model associated with the one or more resources, wherein the propagation model comprises the one or more parameters.

5. The system of claim 4, wherein initiating the one or more actions comprises:
identifying a version of a resource that is not impacted by the event based on the propagation model; and
propagating the version of the resource to the one or more resources.

6. The system of claim 4, wherein initiating the one or more actions comprises:
generating one or more alerts associated with the event;
identifying at least one resource that is to be impacted at a future time period based on the provisioning frequency and dependencies in the propagation model; and
transmitting the one or alerts to one or more users associated with the at least one resource.

7. The system of claim 6, wherein initiating the one or more actions comprises automatically modifying the provisioning frequency associated with the one or more models.

8. The system of claim 4, wherein initiating the one or more actions comprises:
identifying at least one high impact resource from the one or more resources based on the propagation model; and
automatically decommissioning the at least one high impact resource.

9. A computer program product for reinforcing resource integrity of one or more applications based on performing event impact analysis, the computer program product comprising a non-transitory computer-readable storage medium having computer executable instructions for causing a computer processor to perform the steps of:
determining occurrence of an event based on identifying one or more triggers;
performing event impact analysis associated with one or more resources of an entity; and
initiating an event response based on performing event impact analysis, wherein the event response comprises initiating one or more actions to reinforce and retain resource integrity of the one or more resources.

10. The computer program product of claim 9, wherein determining occurrence of the event is based on receiving an input from at least one user of at least one resource of the one or more resources.

11. The computer program product of claim 9, wherein determining occurrence of the event is based on:
crawling into the one or more resources; and
monitoring error logs of the one or more resources.

12. The computer program product of claim 9, wherein performing the impact analysis comprises:
gathering one or more parameters associated with the one or more resources, wherein the one or more parameters comprise provisioning frequency and dependencies of the one or more resources; and
generating a propagation model associated with the one or more resources, wherein the propagation model comprises the one or more parameters.

13. The computer program product of claim 12, wherein initiating the one or more actions comprises:
identifying a version of a resource that is not impacted by the event based on the propagation model; and
propagating the version of the resource to the one or more resources.

14. The computer program product of claim 12, wherein initiating the one or more actions comprises:
generating one or more alerts associated with the event;
identifying at least one resource that is to be impacted at a future time period based on the provisioning frequency and dependencies in the propagation model; and
transmitting the one or alerts to one or more users associated with the at least one resource.

15. A computer implemented method for reinforcing resource integrity of one or more applications based on performing event impact analysis, the method comprising:
determining occurrence of an event based on identifying one or more triggers;
performing event impact analysis associated with one or more resources of an entity; and
initiating an event response based on performing event impact analysis, wherein the event response comprises initiating one or more actions to reinforce and retain resource integrity of the one or more resources.

16. The computer implemented method of claim 15, wherein determining occurrence of the event is based on receiving an input from at least one user of at least one resource of the one or more resources.

17. The computer implemented method of claim 15, wherein determining occurrence of the event is based on:
crawling into the one or more resources; and
monitoring error logs of the one or more resources.

18. The computer implemented method of claim 15, wherein performing the impact analysis comprises:
gathering one or more parameters associated with the one or more resources, wherein the one or more parameters comprise provisioning frequency and dependencies of the one or more resources; and
generating a propagation model associated with the one or more resources, wherein the propagation model comprises the one or more parameters.

19. The computer implemented method of claim 18, wherein initiating the one or more actions comprises:
identifying a version of a resource that is not impacted by the event based on the propagation model; and
propagating the version of the resource to the one or more resources.

20. The computer implemented method of claim 18, wherein initiating the one or more actions comprises:
generating one or more alerts associated with the event;
identifying at least one resource that is to be impacted at a future time period based on the provisioning frequency and dependencies in the propagation model; and
transmitting the one or alerts to one or more users associated with the at least one resource.
